(19) United States
(12) Patent Application Publication
(10) Pub. No.: US 2003/0174262 A1
(43) Pub. Date: Sep. 18, 2003

(54) Liquid crystal display and method of manufacturing the same

(75) Inventors: Mari Sugawara, Kawasaki (JP); Tetsuya Kobayashi, Kawasaki (JP); Tetsuya Hamada, Kawasaki (JP); Takeshi Gotoh, Kawasaki (JP); Keiji Hayashi, Kawasaki (JP); Toshihiro Suzuki, Kawasaki (JP)

Correspondence Address: GREER, BURNS & CRAIN, 300 S WACKER DR, 25TH FLOOR, CHICAGO, IL, 60606, US

(73) Assignee: FUJITSU DISPLAY TECHNOLOGIES CORPORATION

(21) Appl. No.: 10/386,135

(22) Filed: Mar. 11, 2003

(30) Foreign Application Priority Data
Mar. 11, 2002 (JP) 2002-065196

(51) Int. Cl. G02F 1/1335

(52) U.S. Cl. 349/65

(57) ABSTRACT

There is provided a liquid crystal display having good display characteristics and a method of driving the same. Pixel data is written in plural pixels on one gate bus line at a top end of a display area at a first point in time on a line sequential basis. At a second point in time, the writing of pixel data in pixels in an upper part of the screen is completed, and writing of pixel data in pixels in a lower part of the screen is started. At a third point in time, the writing of pixel data in the pixels in the lower part of the screen is completed. A fluorescent tube on the upper side of the screen is turned on for a period between a third point in time after the writing of pixel data in the upper part of the screen and a fourth point in time before writing of pixel data for the next frame is started and is turned off in other periods. A fluorescent tube on the lower side of the screen is turned on for a period between a fifth point in time after the writing of pixel data in the lower part of the screen in the preceding frame and a sixth point in time before writing of pixel data in the lower part of the screen is started and is turned off in other periods.

### BACKGROUND OF THE INVENTION

1. Field of the Invention

The present invention relates to a liquid crystal display used as a display section of an information apparatus and a method of driving the same.

2. Description of the Related Art

Displays used as monitors of personal computers (PCs) and television receivers include CRTs (cathode-ray tubes) and liquid crystal displays. FIG. 27 shows changes of the luminance of light emitted by one pixel of a CRT in relation to time, and FIG. 28 shows changes of the luminance of light emitted by one pixel of a liquid crystal display in relation to time. The abscissa axes of FIGS. 27 and 28 represent time, and the ordinate axes represent luminance. As shown in FIG. 27, a CRT performs impulse type display in which a pixel instantaneously emits light only once in one frame (field) as a result of scanning of an electronic beam. On the contrary, as shown in FIG. 28, a liquid crystal display performs hold-type display in which a pixel keeps on emitting light with substantially constant luminance in one frame after new data is written in the next frame.

Further, a liquid crystal display requires a light source device such as a backlight unit because it emits no light unlike a CRT that emits light by it self. Back light units include direct type units that are constituted of a plurality of fluorescent tubes (cold cathode tubes) as linear light sources provided on a backside of a liquid crystal display panel and edge-light type units that are constituted of fluorescent tubes provided at an edge of a light guide plate provided on a backside of a liquid crystal display panel. FIG. 29 shows a configuration of a direct type light source device. As shown in FIG. 29, a plurality of fluorescent tubes 112 are provided on a backside of a diffuser 110.

A liquid crystal display employing the hold type display method suffers from a blur at the contour of an image when a dynamic image is displayed. In order to improve the quality of a dynamic image by making light from each pixel similar to that in a display employing the impulse type display method, a method has been conceived in which fluorescent tubes in a region where pixel data has already been written are sequentially turned on. However, it is difficult to achieve uniform luminance throughout a display area with a direct type light source device because it is likely to have irregularities of luminance depending on the positions of the fluorescent tubes 112 and differences in the quantity of light and chromaticity between the fluorescent tubes 112. Further, differences in deterioration between the fluorescent tubes 112 are likely to be recognized as irregularities of luminance, and the power consumption of the light source device is increased when a great number of the fluorescent tubes 112 are used to improve display quality. For such reasons, the main stream is edge-light type light source devices constituted of linear light sources provided at an edge of a light guide plate.

FIG. 30 shows a configuration of an edge-light type light source device. As shown in FIG. 30, florescent tubes 116 are provided at an edge of a planar light guide plate 114 and another edge in a face-to-face relationship with that edge.

When an edge-light type light source device is used, a blur occurs at the contour of a dynamic image that is displayed, although irregularities of luminance are less likely to occur than when a direct type light source is used. A blur at the contour of an image attributable to the hold type display method occurs because of the fact that image data for each horizontal line for drawing a moving object is fixed in one frame period whereas the viewpoint of a viewer of the dynamic image changes with time while tracing the moving object in the dynamic image. Further, since the speed of response of liquid crystal molecules in a liquid crystal display is low relative to frame periods at which pixel data is rewritten, a blur of a contour is also recognized because of the fact that pixels are recognized as having averaged luminance by a viewer while the liquid crystal is responding to rewriting of data. In the case of a normally black mode liquid crystal display, the response speed of liquid crystal molecules is low especially when low tones near black are rewritten because a low voltage applied to the liquid crystal layer is low.

### SUMMARY OF THE INVENTION

The invention provides a liquid crystal display having good display characteristics and a method of driving the same.

The above problem is solved by a liquid crystal display characterized in that it includes a liquid crystal display panel having a two substrates provided opposite to each other and a liquid crystal sealed between the two substrate and a light source device having a planar light guide plate for guiding light incident thereupon and a plurality of linear light sources that are provided at an edge of the planer light guide plate and that are turned on for a predetermined turn-on time within a frame period at a predetermined blinking frequency and at different timing.

The above problem is solved by a method of driving a liquid crystal display having a plurality of planar light sources, characterized in that it has the step of turning on the plurality of planar light sources for predetermined respective turn-on times within a frame period at different timing.

The above problem is solved by a method of driving a liquid crystal display, characterized in that it has the steps of calculating luminance data of each pixel based on the tone of the pixel in a predetermined period, calculating a duty ratio that is the ratio of a turn-on time to the predetermined period based on at least any of a maximum value, a minimum value or an average value of the luminance data, and blinking planar light sources based on the duty ratio.

### BRIEF DESCRIPTION OF THE DRAWINGS

FIG. 1 shows a configuration of a liquid crystal display according to Embodiment 1-1 in a first mode for carrying out the invention;

FIG. 2 shows the configuration of the liquid crystal display according to Embodiment 1-1 in the first mode for carrying out the invention;

FIGS. 3A, 3B, and 3C show a method of driving the liquid crystal display according to Embodiment 1-1 in the first mode for carrying out the invention;

FIGS. 4A, 4B, and 4C show the method of driving the liquid crystal display according to Embodiment 1-1 in the first mode for carrying out the invention;

FIGS. 5A, 5B, and 5C show the method of driving the liquid crystal display according to Embodiment 1-1 in the first mode for carrying out the invention;

FIG. 6 shows a configuration of a liquid crystal display according to Embodiment 1-2 in the first mode for carrying out the invention;

FIG. 7 shows a configuration of a liquid crystal display according to Embodiment 1-3 in the first mode for carrying out the invention;

FIG. 8 shows a modification of the configuration of the liquid crystal display according to Embodiment 1-3 in the first mode for carrying out the invention;

FIG. 9 shows a configuration of a liquid crystal display according to Embodiment 1-4 in the first mode for carrying out the invention;

FIG. 10 shows a configuration of the liquid crystal display according to Embodiment 1-4 in the first mode for carrying out the invention;

FIG. 11 shows a configuration of the liquid crystal display according to Embodiment 1-4 in the first mode for carrying out the invention;

FIG. 12 is a functional block diagram showing a configuration of a liquid crystal display according to Embodiment 2-1 in a second mode for carrying out the invention;

FIG. 13 is a flow chart showing a method of driving the liquid crystal display according to Embodiment 2-1 in the second mode for carrying out the invention;

FIG. 14 is a flow chart showing a method of driving a liquid crystal display according to Embodiment 2-2 in the second mode for carrying out the invention;

FIG. 15 is a flow chart showing a method of driving a liquid crystal display according to Embodiment 2-3 in the second mode for carrying out the invention;

FIG. 16 is a flow chart showing a method of driving a liquid crystal display according to Embodiment 2-4 in the second mode for carrying out the invention;

FIG. 17 is a flow chart showing the method of driving the liquid crystal display according to Embodiment 2-4 in the second mode for carrying out the invention;

FIG. 18 is a flow chart showing a method of driving a liquid crystal display according to Embodiment 2-5 in the second mode for carrying out the invention;

FIG. 19 is a flow chart showing the method of driving the liquid crystal display according to Embodiment 2-5 in the second mode for carrying out the invention;

FIG. 20 is a flow chart showing the method of driving the liquid crystal display according to Embodiment 2-5 in the second mode for carrying out the invention;

FIG. 21 is a flow chart showing the method of driving the liquid crystal display according to Embodiment 2-5 in the second mode for carrying out the invention;

FIG. 22 is a flow chart showing the method of driving the liquid crystal display according to Embodiment 2-5 in the second mode for carrying out the invention;

FIG. 23 is a flow chart showing the method of driving the liquid crystal display according to Embodiment 2-5 in the second mode for carrying out the invention;

FIG. 24 is a flow chart showing the method of driving the liquid crystal display according to Embodiment 2-5 in the second mode for carrying out the invention;

FIG. 25 is a flow chart showing a method of driving a liquid crystal display according to Embodiment 2-6 in the second mode for carrying out the invention;

FIG. 26 shows a modification of a configuration of a liquid crystal display in the second mode for carrying out the invention;

FIG. 27 is a graph showing changes in the luminance of light emitted by one pixel of a CRT with time;

FIG. 28 is a graph showing changes in the luminance of light emitted by one pixel of a liquid crystal display with time;

FIG. 29 shows a configuration of a direct type light source device; and

FIG. 30 shows a configuration of an edge-light type light source device.

### DESCRIPTION OF THE PREFERRED EMBODIMENTS

[First Mode for Carrying out the Invention]

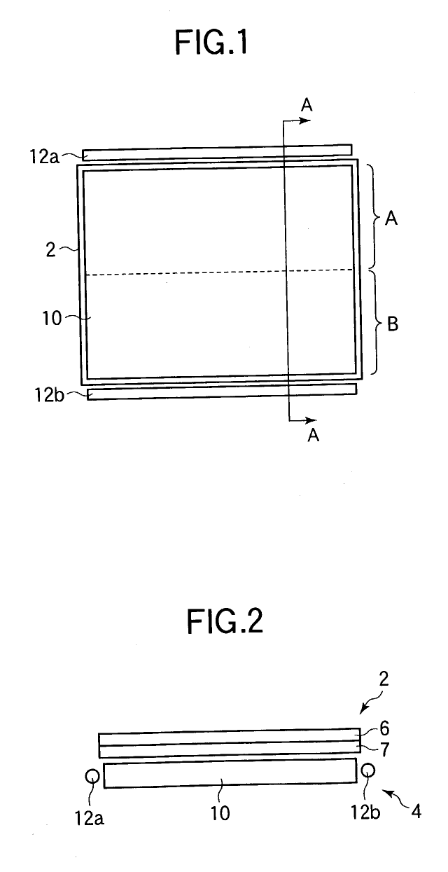

A liquid crystal display and a method of driving the same in a first mode for carrying out the invention will now be described with reference to FIGS. 1 to 11. In the present mode for carrying out the invention, a linear light source provided at an edge of a light guide plate and another linear light source provided at another edge in a face-to-face relationship are blinked at different times. This reduces a data retention time (light-emitting time) and mitigates a blur when a dynamic image is displayed. Data for pixels in a display region on the side of one of the linear slight sources is rewritten while the linear light source is off and, in the mean time, the other linear light source is turned on to perform display, which makes it possible to mitigate a blur attributable to rewriting of data.

The turn-on time of the light source device is increased when the display area as a whole has a high tone. When the display area as a whole has a low tone, the turn-on time of the light source device is decreased to convert a tone signal such that a relatively high voltage is applied to the liquid crystal layer. This makes it possible to mitigate a blur that is attributable to the response speed of liquid crystal molecules without reducing the luminance of white display. A description will now be made with reference to Embodiment 1-1 to 1-4.

(Embodiment 1-1)

A description will now be made with reference to FIGS. 1 to 5C on a liquid crystal display and a method of driving the same according to Embodiment 1-1 in the present mode for carrying out the invention. FIG. 1 shows a configuration of the liquid crystal display of the present embodiment, and FIG. 2 shows a section of the liquid crystal display taken along the line A-A in FIG. 1. As shown in FIGS. 1 and 2, the liquid crystal display whose diagonal dimension is 15 inches for example has a liquid crystal display panel 2 and an edge-light type backlight unit 4. The liquid crystal display panel 2 has two glass substrates 6 and 7 and a liquid crystal (not shown) sealed between the substrates 6 and 7. The backlight unit 4 has a planar light guide plate 10 and two fluorescent tubes 12a and 12b provided at two respective edges of the planar light plate 10 facing each other. The fluorescent tubes 12a and 12b are linear light source extending along the edges of the planar light guide plate 10. The florescent tube 12a that is located above a display area illuminates a region A that is an upper half of the display area, and the florescent tube 12b that is located under the display area illuminates a region B that is a lower half of the display area.

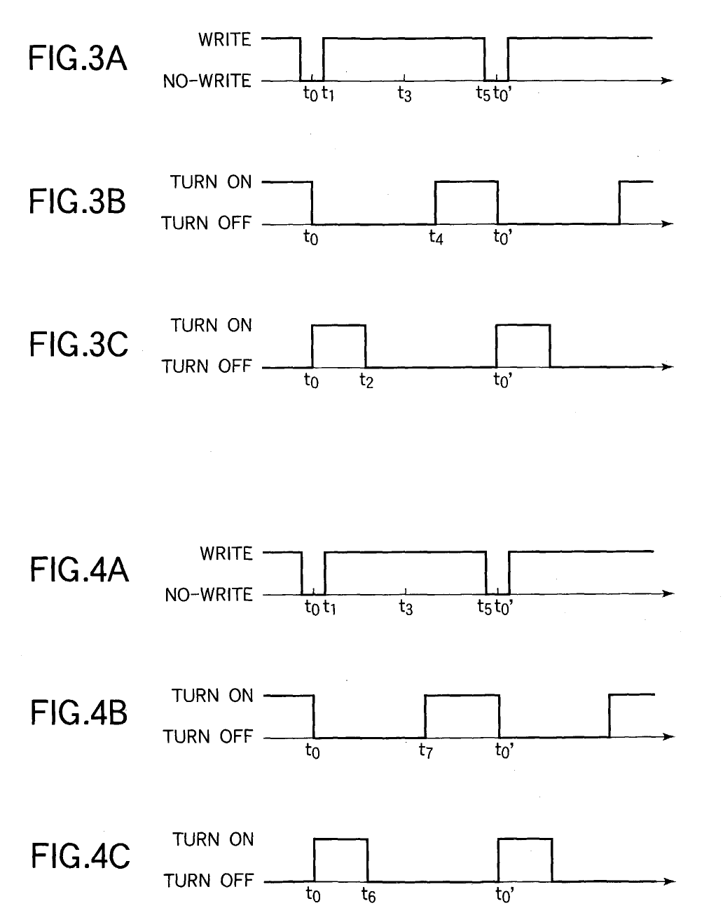

FIGS. 3A, 3B and 3C show timing of writing of pixel data in the display area and blinking of the florescent tubes 12a and 12b. FIG. 3A shows whether pixel data is written in the display area or not (write/no-write). FIG. 3B shows blinking (turn on/turn off) of the fluorescent tube 12a, and FIG. 3C shows blinking of the fluorescent tube 12b. The abscissa axes in FIGS. 3A, 3B, and 3C represent time. As shown in FIG. 3A, pixel data is written in the display area in the period from a time t1 to a time t5 within one frame period from a time t0 to a time t0′. Pixel data is written on a line sequential basis starting with a plurality of pixels for one gate bus line at the top of the display area at the time t1. At the time t3, the writing of pixel data in the pixels of the region A is completed, and writing of data in the pixels in the region B is started. The writing of pixel data in the pixels in the region B is completed at the time t5.

As shown in FIG. 3B, the fluorescent tube 12a on the side of the region A is turned on for the period from a time t4 when the writing of pixel data in the region A has been completed and until the time t0′ when the writing of pixel data in the next frame has not been started yet and is turned off in other periods. For example, the ratio of the turn-on time of the fluorescent tube 12a to one frame period (hereinafter referred to as duty ratio) is 30%.

As shown in FIG. 3C, the fluorescent tube 12b on the side of the region B is turned on for the period from the time t0 when the writing of pixel data in the region B in the preceding frame has been completed and until a time t2 when the writing of pixel data in region B has not been started yet and is turned off in other periods. For example, the duty ratio of the fluorescent tube 12b is 30%.

Thus, the light source on the side of a region whose pixel data is being rewritten is turned off during the rewriting of the data as far as possible. In one frame period, there is a phase difference φ greater than 180° (φ>180°) between the time t0 at which the fluorescent tube 12b is turned on and the time t4 when the fluorescent tube 12a is turned on. In order to match the plinking period of the fluorescent tubes 12a and 12b and the frame period, driving circuits for light source device that blinks the fluorescent tubes 12a and 12b are synchronized by a start pulse that indicates the beginning of one frame.

In the present mode for carrying out the invention, the frame frequency and the blinking frequency of the fluorescent tubes 12a and 12b are both 60 Hz, and the duty ratios are in the range from 20 to 100% (30% in FIGS. 3A, 3B, and 3C). Since the speed of response of liquid crystal molecules is in the range from several msec to a lot of msec, the light source device is turned on when the response of liquid crystal molecules of each pixel whose pixel data has been rewritten has substantially been completed. Therefore, desired image data (luminance) can be displayed as it is. Since light-emitting time is shortened by blinking the fluorescent tubes 12a and 12b, a blur of a dynamic image can be mitigated to achieve good display characteristics.

In the present embodiment, the liquid crystal display used has a configuration similar to that of a liquid crystal display according to the related art, and the backlight scans a plurality of regions in the display area with the timing of blinking varied. The display characteristics can be improved further in the vicinity of the boundary between the regions A and B by providing the planar light guide plate 10 with scattering characteristics and reflecting characteristics adapted such that light from the fluorescent tube 12a is primarily guided to the region A and such that light from the fluorescent tube 12b is primarily guided to the region B.

To display an image that has a relatively high luminance in the region A and a relatively low luminance in the region B, the difference in luminance between the upper and lower parts of the screen can be provided by setting a great duty ratio for the fluorescent tube 12a and a small duty ratio for the fluorescent tube 12b. FIGS. 4A, 4B, and 4C show the timing of blinking of the fluorescent tubes 12a and 12b whose duty ratios are different from each other. As shown in FIGS. 4A, 4B, and 4C, the fluorescent tube 12a on the side of the region A is turned on for a longer time compared to the fluorescent tube 12b on the side of the region B. For example, when an image is displayed in which sky appears in the upper part of the display screen and a forest appears in the lower part, the blue sky and the whiteness of clouds can be highlighted, and a dark color of trees can be emphasized. Further, since a blur attributable to the speed of response of the liquid crystal can be mitigated, leaves of the trees swinging in wind can be clearly recognized. The duty ratios of the fluorescent tubes 12a and 12b are desirably kept at 40% or less because an extremely great difference in luminance between the upper and lower parts of the display screen changes the impression of the image undesirably.

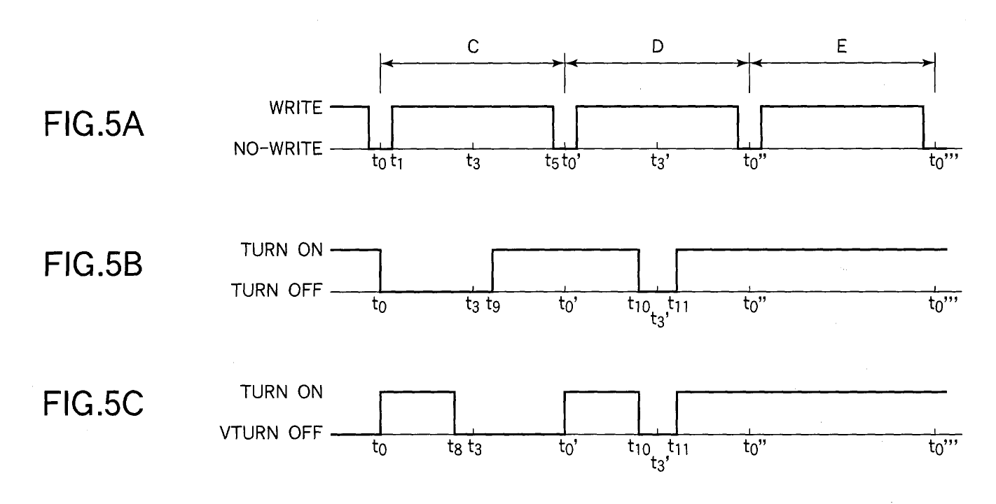

For example, the duty ratios of the fluorescent tubes 12a and 12b may be changed from frame to frame within the range from 20 to 100%. FIGS. 5A, 5B, and 5C show an example in which the duty ratios of the fluorescent tubes 12a and 12b are changed from frame to frame. As shown in FIGS. 5A, 5B and 5C, both of the fluorescent tubes 12a and 12b have a duty ratio of 40% in a frame period C. In a frame period D, both of the fluorescent tubes 12a and 12b have a duty ratio of 80%. In a frame period E, both of the fluorescent tubes 12a and 12b have a duty ratio of 100%.

When both of the fluorescent tubes 12a and 12b have a duty ratio of 50% or more, the two fluorescent tubes 12a and 12b must be simultaneously turned on somewhere in one frame period. At this time, in the case of a dynamic image, the fluorescent tubes 12a and 12b are preferably turned off to mitigate any blur when pixel data is written in pixels in the middle of the display screen because a viewer focuses on the middle of the display screen. Therefore, when the duty ratios of the fluorescent tubes 12a and 12b are increased, e.g., when they have a duty ratio of 40% or more, the tubes are turned on twice in a frame period, i.e., at the beginning and end of the same, as in the case of the frame period D shown in FIGS. 5A, 5B, and 5C and are turned off in the middle of the same (in the vicinity of a time t3′). As a result, a blur in the middle of the display screen is mitigated to provide good display characteristics when the duty ratios are increased to about 80% to improve display luminance. Blinking periods (the inverse numbers of blinking frequencies) in the frame periods D and E are defined as (t0″-t0′) and (t0′″-t0″), respectively.

(Embodiment 1-2)

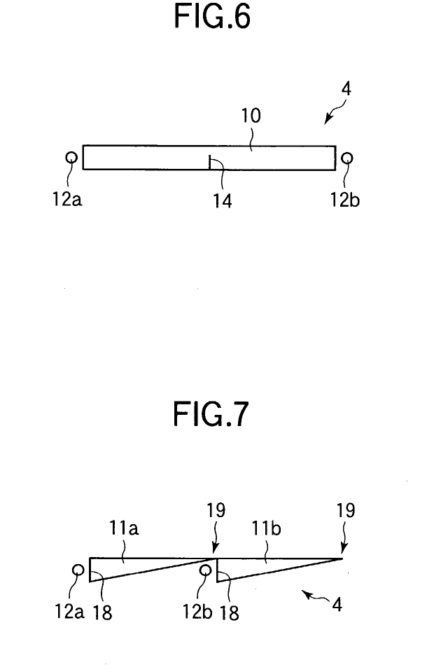

A liquid crystal display according to Embodiment 1-2 in the present mode for carrying out the invention will now be described with reference to FIG. 6. FIG. 6 shows a schematic sectional configuration of a backlight unit 4 of the liquid crystal display of the present embodiment. As shown in FIG. 6, the backlight unit 4 has a planar light guide plate 10 that is partially split by a splitting surface 14 formed in the vicinity of the boundary between regions A and B as shown in FIG. 1. For example, a high reflective material such as aluminum is vacuum-deposited on the splitting surface 14. As a result light which has been emitted by a fluorescent tube 12a and which has reached the neighborhood of the splitting surface 14 is reflected by the splitting surface 14 instead of entering the region B of the planar light guide plate 10 and is guided into the region A again.

In the present embodiment, the regions A and B can be substantially separately illuminated with fluorescent tubes 12a and 12b, and the utilization of light in each of the regions A and B of the planar light guide plate 10 is improved. This makes it possible to achieve an improvement of display characteristics over those of Embodiment 1-1.

(Embodiment 1-3)

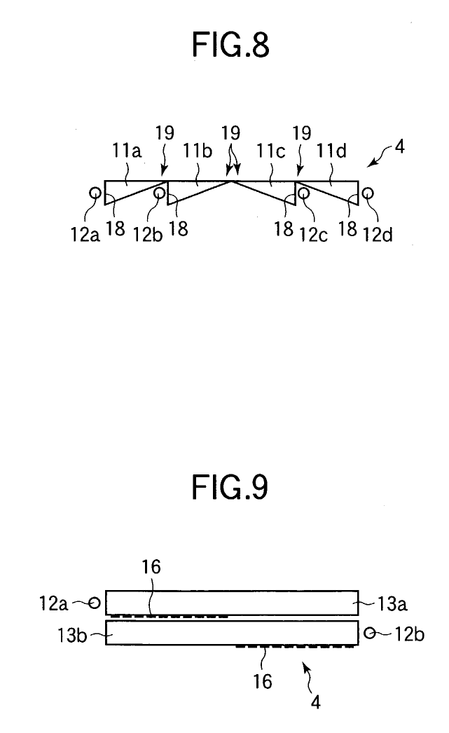

A liquid crystal display according to Embodiment 1-3 in the present mode for carrying out the invention will now be described with reference to FIGS. 7 and 8. FIG. 7 shows a schematic sectional configuration of a backlight unit 4 of the liquid crystal display of the present embodiment. As shown in FIG. 7, the backlight unit 4 has two wedge-shaped planar light guide plates 11a and 11b. Fluorescent tubes 12a and 12b are provided in the vicinity of respective light entering surfaces 18 of the planar light guide plates 11a and 11b at edges on one end thereof facing apical angles of the same. An end 19 of the planar light guide plate 11a and the light entering surface 18 of the other planar light guide plate 11b are located substantially contiguously to each other. The present embodiment provides advantages similar to those of Embodiments 1-1 and 1-2.

FIG. 8 shows a configuration of a backlight unit 4 of a modification of the liquid crystal display according to the present embodiment. As shown in FIG. 8, the backlight unit 4 has four wedge-shaped planar light guide plates 11a to 11d. Fluorescent tubes 12a to 12d are provided in the vicinity of respective light entering surfaces 18 of the planar light guide plates 12a to 12d at one end thereof. An end 19 of the planar light guide plate 11a and the light entering surface 18 of the planar light guide plate 11b are located substantially contiguously to each other. An end 19 of the planar light guide plate 11d and the light entering surface 18 of the planar light guide plate 11c are located substantially contiguously to each other. An end 19 of the planar light guide plate 11b and an end 19 of the planar light guide plate 11c are located substantially contiguously to each other.

In the example in which the display area is divided into regions A and B as shown in FIG. 1, the backlight units 12a and 12b may be turned on when liquid crystal molecules in lower parts of the regions A and B have not responded yet, and it is difficult to turn the backlight units 12a and 12b on at timing that is optimum for the entire display area.

In the present modification, the area can be divided into smaller parts, and the fluorescent tubes 12a to 12d can be blinked in better adaptation to the timing of rewriting of pixel data. This makes it possible to achieve good display characteristics even in the middle of the display area (the lower part of the region A) and the bottom of the display area (the lower part of the region B).

(Embodiment 1-4)

A liquid crystal display according to Embodiment 1-4 in the present mode for carrying out the invention will now be described with reference to FIGS. 9 to 11. FIG. 9 shows a schematic sectional configuration of a backlight unit 4 of the liquid crystal display of the present embodiment. As shown in FIG. 9, the backlight unit 4 has a configuration in which two planar light guide plates 13a and 13b having substantially the same shape are stacked one over the other. A fluorescent tube 12a is provided at an edge of the planar light guide plate 13a, and a fluorescent tube 12b is provided at an edge of the planar light guide plate 13b on the other side of the stack.

A scattering pattern 16 is formed in a region A of a backside of the planar light guide plate 13a that is provided closer to a liquid crystal display panel 2 which is not shown (located upward in the figure), the region A being closer to the fluorescent tube 12a. The scattering pattern 16 scatters light that is guided in the planar light guide plate 13a to cause it to exit the same toward the liquid crystal display panel 2. A scattering pattern 16 is formed in a region B of a backside of the planner light guide plate 13b closer to the fluorescent tube 12b. Thus, the fluorescent tube 12a illuminates the region A on the upper part of the display area, and the fluorescent tube 12b illuminates the region B on the upper part of the display area.

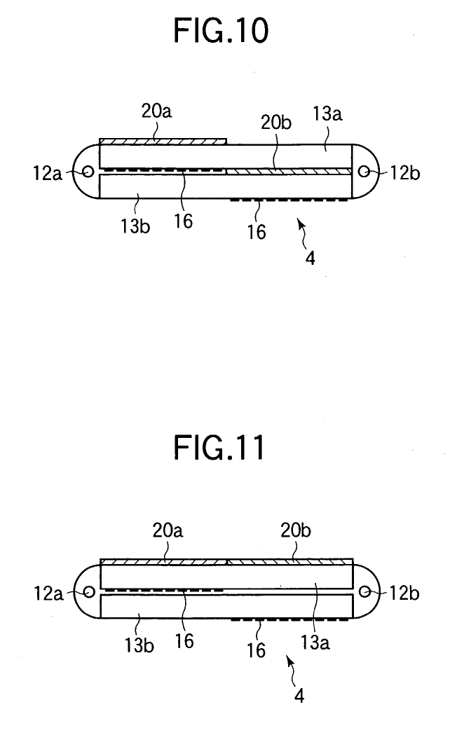

FIG. 10 shows a configuration of a backlight unit 4 of a modification of the liquid crystal display according to the present embodiment. As shown in FIG. 10, two planar light guide plates 13a and 13b share fluorescent tubes 12a and 12b that are provided at both edges thereof. Optical shutters 20a and 20b are provided on a side of the planar light guide plates 13a and 13b facing toward a liquid crystal display panel 2 (upward in the figure). The optical shutter 20a is provided on a left half of the surface of the planar light guide plate 13a (or the top side of the display screen), and the optical shutter 20b is provided on a right half of the surface of the planar light guide plate 13b (or the bottom side of the display screen). Polymer-scattering liquid crystal cells whose optical transmittance changes depending on the strength of an electric field are used as the optical shutters 20a and 20b. Light may be blocked using other types of liquid crystal cells or doors that are mechanically opened and closed. For example, the optical shutters 20a and 20b have a light-reflecting surface on a side thereof toward the planar light guide plates 13a and 13b and have a light-absorbing surface on a side thereof facing toward the liquid crystal display panel 2.

FIG. 11 shows a backlight unit 4 of another modification of the liquid crystal display according to the present embodiment. As shown in FIG. 11, the backlight unit 4 has optical shutters 20a and 20b provided on a side a planar light guide plate 13a facing toward a liquid crystal display panel 2. The optical shutters 20a and 20b may be provided on a side of the liquid crystal display panel 2 facing toward the backlight unit 4.

While two planar light guide plates 13a and 13b are stacked one over the other in the present embodiment, a greater number of planar light guide plates may be stacked to divide the display area into a greater number of regions that can be sequentially scanned and illuminated where there is no restriction on the volume of the liquid crystal display.

In the present mode for carrying out the invention, the fluorescent tubes 12a and 12b provided above and below the display area are blinked in synchronism with writing of pixel data. The fluorescent tube 12a on the side of the region A is turned off with the fluorescent tube 12b on the side of the region B turned on while pixel data is written in the region A that is an upper half of the display area. The fluorescent tube 12b on the side of the region B is turned off with the fluorescent tube 12a on the side of the region A turned on while pixel data is written in the region B that is a lower half of the display area. This makes it possible to illuminate each of the regions with the backlight unit 4 when pixel data has been written in the region and liquid crystal molecules have substantially responded to the same. Since turn-on time in one frame period can be reduced, data retention time can be shortened. This makes it possible to mitigate a blur of a dynamic image and to thereby improve display characteristics. The present mode for carrying out the invention can be easily implemented because there is substantially no increase in the number of components of a liquid crystal display except for a driving circuit for the backlight unit 4. Since the back light unit 4 of a liquid crystal display in the present mode for carrying out the invention is an edge light type, the liquid crystal display is unlikely to have irregularities of luminance on the display screen thereof.

[Second Mode for Carrying out the Invention]

A liquid crystal display and a method for driving the same in a second mode for carrying out the invention will now be described with reference to Embodiments 2-1 to 2-6.

The brightness of display of a liquid crystal display has recently been improved and is approaching the brightness of CRTs. In particular, there is a recent tend toward light source devices having small sizes and higher luminance. The brightness of display of a transmissive liquid crystal display is improved by increasing transmittance of the liquid crystal display panel and increasing the brightness of the light source device thereof when it displays white.

However, light can leak from a liquid crystal panel even in displaying black if it is irradiated with extremely intense light. Therefore, an increase in the luminance of a light source device results in an increase in the maximum luminance of white display and undesirably results in an increase in the minimum luminance of black display too. Thus, a problem arises in that a contrast ratio between white and black display cannot be improved by increasing the luminance of the light source device. Another problem arises in that display quality is reduced because the display screen does not appear in real black and has high luminance when it is to display black.

For example, in the case of a VA (vertically alignment) mode liquid crystal display, liquid crystal molecules are aligned substantially perpendicularly to the substrate surfaces when no voltage is applied to the liquid crystal layer. In this state, retardation in the liquid crystal layer is substantially 0, and black is displayed in the case of a normally black mode liquid crystal display. However, when the display is viewed in a direction at an angle to the substrate surfaces, leakage of light occurs because there is predetermined retardation is caused by the liquid crystal layer.

In the present mode for carrying out the invention, there is provided a liquid crystal display which has high contrast and excellent display characteristics and a method of driving the same.

In order to solve the above-described problems, in the present mode for carrying out the invention, the luminance of light emitted by a light source device is reduced when an image in black or a low tone near black is to be displayed in a substantially entire display area, and the luminance of light emitted by the light source device is increased when an image in a relatively high tone is to be displayed. This makes it possible to provide a liquid crystal display which has a light maximum luminance and in which the luminance of an image in black or a low tone near black is suppressed to achieve a wide dynamic range.

(Embodiment 2-1)

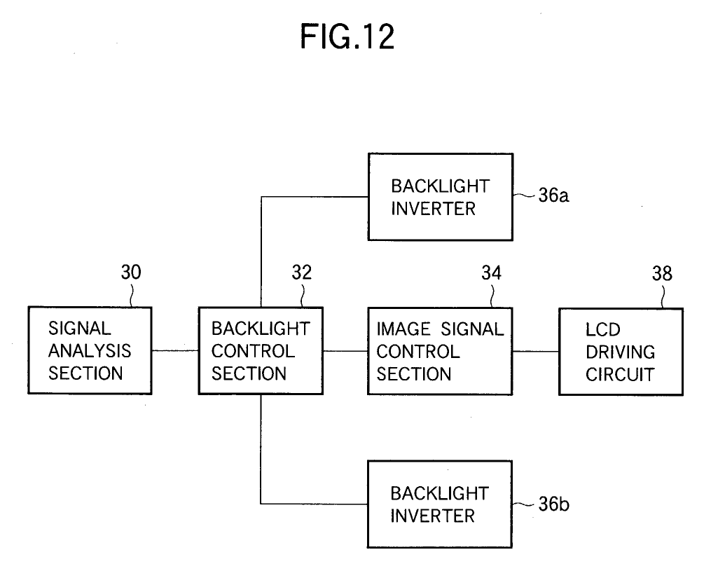

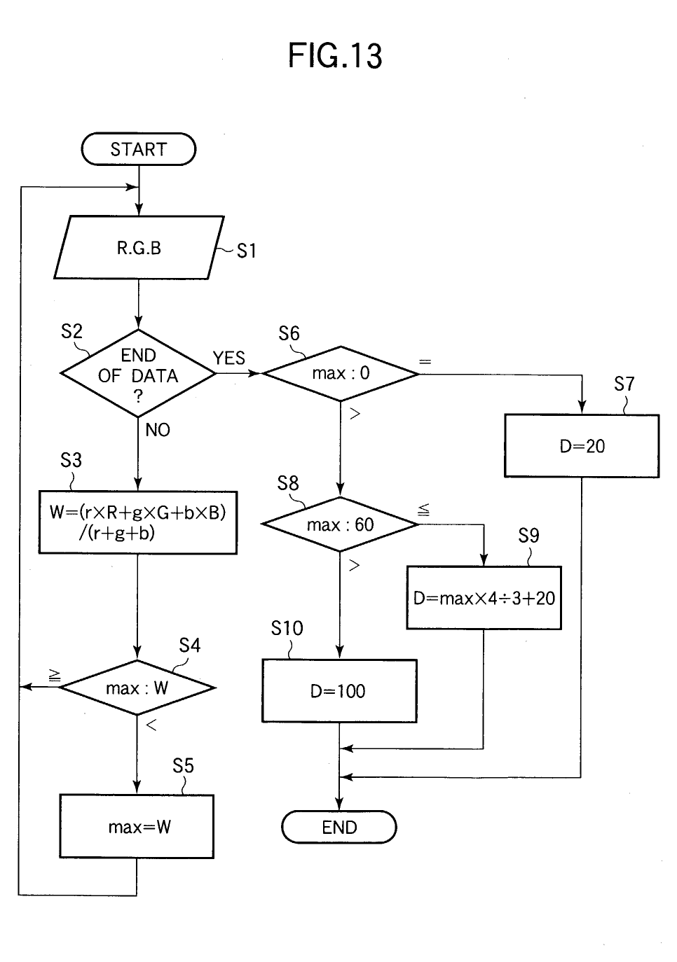

A liquid crystal display and a method of driving the same according to Embodiment 2-1 in the present mode for carrying out the invention will now be described with reference to FIGS. 12 and 13. FIG. 12 is a functional block diagram showing a configuration of a liquid crystal display in the present mode for carrying out the invention. As shown in FIG. 12, the liquid crystal display has a signal analysis section 30 for analyzing an image signal input from the outside to calculate a duty ratio that is a ratio of a turn-on time to one frame period. A backlight control section 32 is connected to the signal analysis section 30. The backlight control section 32 outputs a predetermined blinking signal based on the duty ratio calculated by the signal analysis section 30. Backlight inverters 36a and 36b for blinking a plurality of fluorescent tubes 12a and 12b based on the blinking signal are connected to the backlight control section 32. Further, an image signal control section 34 is connected to the backlight control section 32. An LCD driving circuit 38 for performing control based on the image signal is connected to the image signal control section 34.

A method of driving the liquid crystal display of the present embodiment will now be described with reference to FIG. 13. First, when image signals are input to the signal analysis section 30 from the outside, the signal analysis section 30 calculates data W of luminance on the display screen from image signals in a specified range (e.g., one frame) and calculates a maximum value (max), minimum value (min) and average value of the luminance data W. Further, the signal analysis section 30 calculates a duty ratio based on at least any of the maximum value max, minimum value min and the average value ave.

FIG. 13 is a flow chart showing steps for calculating a duty ratio based on image signals in the present embodiment. For example, red (R), green (G) and blue (B) image signals each having six bits (0 to 63) for each of 1280×768 pixels are input to the signal analysis section 30 in a frame period of 1/60 sec (16.7 msec) (step S1). When the image signals are input (step S2), the signal analysis section 30 calculates luminance data W=(r×R+g×G+b×B)/(r+g+b) having six bits (0 to 63) using the data values of the image signals R, G and B and constants r (e.g., 7), g (e.g., 20) and b (e.g., 5) (step S3). When image signals R, G and B for a certain pixel have data values R=40, G=35 and B=59, luminance data W=39 is obtained. Next, the signal analysis section 30 compares the luminance data W with a maximum value max (whose initial value is 0) (step S4) and, if the luminance data W is greater than the maximum value max (W>max), it stores the luminance data W in a memory that is not shown as a maximum value max (step S5). When the luminance data is equal to or smaller than the maximum value max (W≦max), the process returns to step S1. When image signals in a specified range have been input (step S2) by repeating the above steps, the process proceeds to step S6.

At step S6, the signal analysis section 30 calculates a duty ratio D (%) based on the maximum value max and compares the maximum value max with 0. The process proceeds to step S7 when max=0 and to step S8 when max>0. When max=0, the duty ratio D (%) is set at 20 at step S7. When max>0, the maximum value max is compared with 60 at step S8. When max≦60, the duty ratio D (%) is set at max×4÷3+20 (step S9). When max>60, the duty ratio D (%) is set at 100 (step S10).

Thus, when black is displayed throughout the display screen (max=0), the duty ratio D is decreased to 20% to decrease the luminance of display, which makes it possible to display clear black by suppressing highlights in black that occur depending on the viewing angle. When the maximum value max of the luminance data W is increased to present a screen in a high tone, the duty ratio D may be gradually increased to improve the luminance of display. By changing the duty ratio D in adaptation to the maximum value max, power consumption can be reduced compared to that in a case in which the duty ratio D is always kept at 100% or a similar value. Since a change in the duty ratio D in response to a change in the maximum value max emphasizes a change in the brightness of the display screen, a more striking image can be presented.

(Embodiment 2-2)

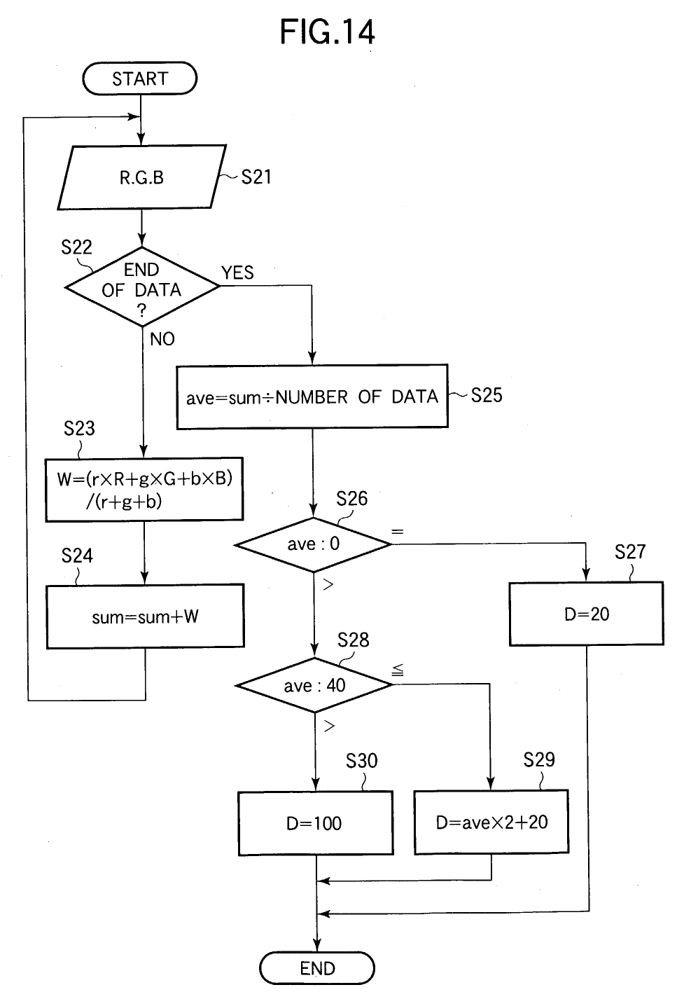

A method of driving a liquid crystal display according to Embodiment 2-2 in the present mode for carrying out the invention will now be described with reference to FIG. 14. In the present embodiment, a duty ratio D is calculated based on an average value ave instead of a maximum value max of luminance data W. FIG. 14 is a flow chart showing steps for calculating a duty ratio D based on image signals in the present embodiment. For example, image signals R, G and B each having six bits (0 to 63) for each of 1280×768 pixels are input to the signal analysis section 30 in a frame period of 1/60 sec (step S21). When the image signals are input (step S22), the signal analysis section 30 calculates luminance data W=(r×R+g×G+b×B)/(r+g+b) using the data values of the image signals R, G and Band constants r, g and b (step S23). The signal analysis section 30 sequentially adds luminance data W to a total value sum (which is initially 0) (step S24). When image signals in a specified range have been input by repeating the above steps (step S22), the total value sum is divided by the number of data (1280×768) to calculate an average value ave (step S25).

Next, the signal analysis section 30 compares the average value ave with 0 (step S26) and sets the duty ratio D at 20 when ave=0 (step S27). When ave>0,the average value ave is compared with 40 (step S28). When ave≦40, the duty ratio D is set at ave×2+20 (step S29). When ave>40, the duty ratio D is set at 100 (step S30).

In the present embodiment, when black is displayed throughout the display screen (ave=0), the duty ratio D is decreased to 20% to decrease the luminance of display, which makes it possible to display clear black by suppressing highlights in black that occur depending on the viewing angle similarly to Embodiment 2-1. When the average value ave of the luminance data W is increased to present a screen in a high tone, the duty ratio D may be increased to improve the luminance of display. By changing the duty ratio D in adaptation to the average value ave, power consumption can be reduced compared to that in a case in which the duty ratio D is always kept at 100% or a similar value.

(Embodiment 2-3)

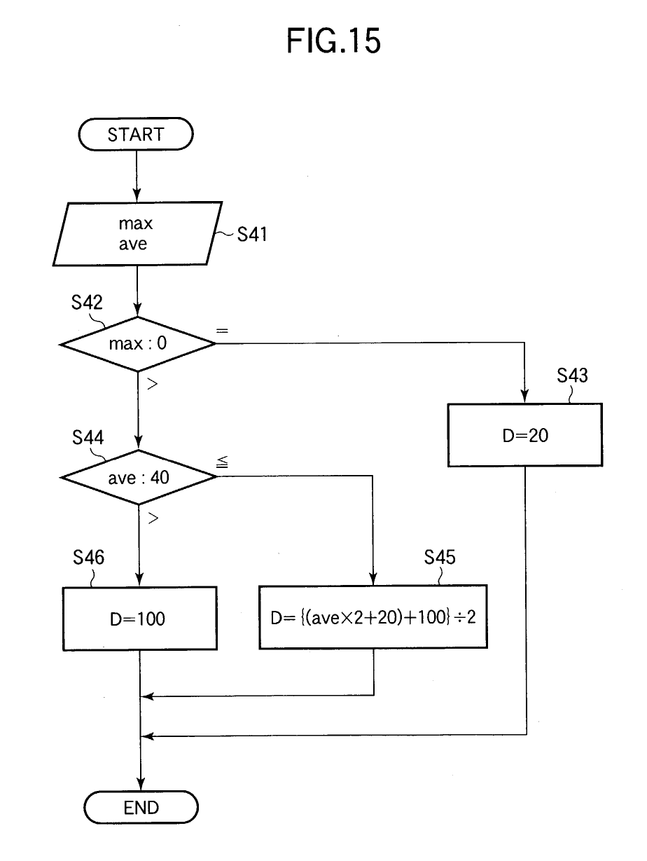

A-method of driving a liquid crystal display according to Embodiment 2-3 in the present mode for carrying out the invention will now be described with reference to FIG. 15. In the present embodiment, a duty ratio D is calculated based on a maxium value max and an average value ave of luminance data W. FIG. 15 is a flow chart showing steps for calculating a duty ratio D based on a maximum value max and an average value ave of luminance data W. First, the signal analysis section 30 reads a maximum value max and an average value ave that have been calculated through steps shown in FIGS. 13 and 14 from a memory (step S41). The signal analysis section 30 compares the maximum value max with 0 (step S42) and sets the duty ratio D at 20 when max=0 (step S43). When max>0, the average value ave is compared with 40 (step S44). When ave≦40, the duty ratio D is set at {(ave×2+20)+100}÷2 (step S45). When ave>40, the duty ratio is set at 100 (step S46).

In the present embodiment, the duty ratio D is set at an average value between a value that is calculated at step S29 in Embodiment 2-2 and 100 when max≠0. Therefore, points where luminance data W≠0 on a display screen can be displayed with high luminance when ave=0 and max≠0. For example, when a white spot appears on a screen that displays black substantially in the entire area thereof, a viewer tends to gaze at the white spot rather than black. In such a case, it is important to increase the luminance of white even though the luminance of black is also increased.

(Embodiment 2-4)

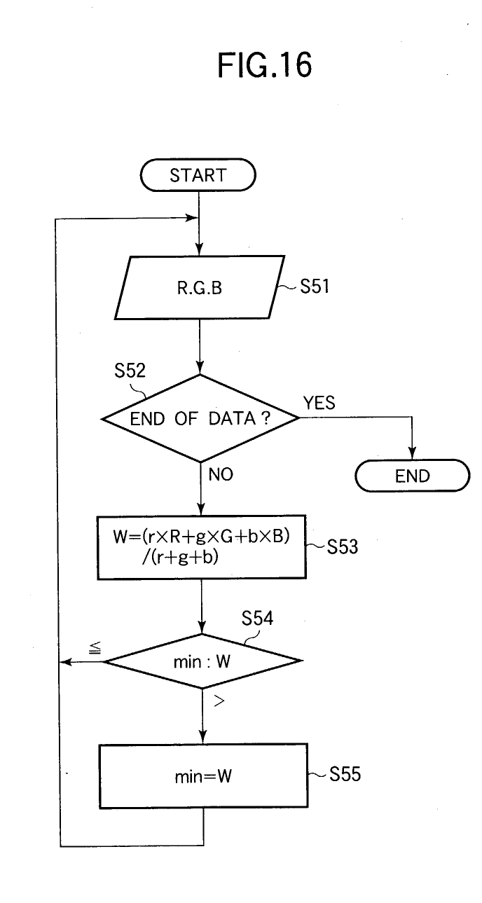

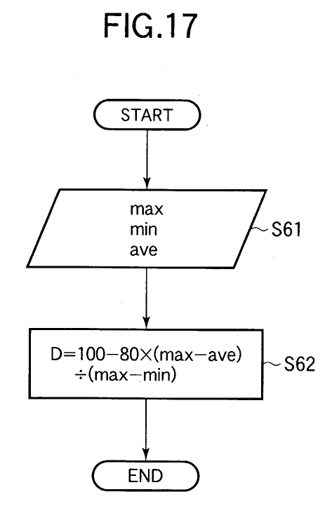

A method of driving a liquid crystal display according to Embodiment 2-4 in the present mode for carrying out the invention will now be described with reference to FIGS. 16 and 17. In the present embodiment, a duty ratio D is calculated based on a maximum value max, a minimum value min and an average value ave of luminance data W when the maximum value max of the luminance data W is not a possible greatest value (e.g., 63).

The signal analysis section 30 calculates a maximum value max and an average value ave through steps shown in FIGS. 13 and 14 and also calculates a minimum value min. FIG. 16 is a flow chart showing steps for calculating a minimum value min of luminance data W from image signals R, G and B. For example, image signals R, G and B each having six bits (0 to 63) for each of 1280×768 pixels are input to the signal analysis section 30 in a frame period of 1/60 sec (step S51). When the image signals are input (step S52), the signal analysis section 30 calculates luminance data W=(r×R+g×G+b×B)/(r+g+b) using the data values of the image signals R, G and B and constants r, g and b (step S53). The signal analysis section 30 compares the luminance data W and a minimum value min (which is initially 0) (step S54) and, if the luminance data W is smaller than the minimum value min (W<min), the luminance data W is stored in a memory as a minimum value min (step S55). When the luminance data W is equal to or greater than he minimum value min (W≧min), the process returns to step S51. The above steps are repeated until image signals in a specified range are input.

FIG. 17 is a flow chart of steps for calculating a duty ratio D based on a maximum value max, a minimum value min, and an average value ave of luminance data W. As shown in FIG. 17, the signal analysis section 30 reads the maximum value max, the minimum value min and the average value ave from a memory (step S61). Next, it calculates a duty ratio D=100−{(max−ave)/(max−min)}×80 (or D={(ave−min)/(max−min)}×80+20) (step S62).

In the present embodiment, for example, D=95 (%) when max=40; min=5; and ave=38, and it is therefore possible to display an image with high luminance.

(Embodiment 2-5)

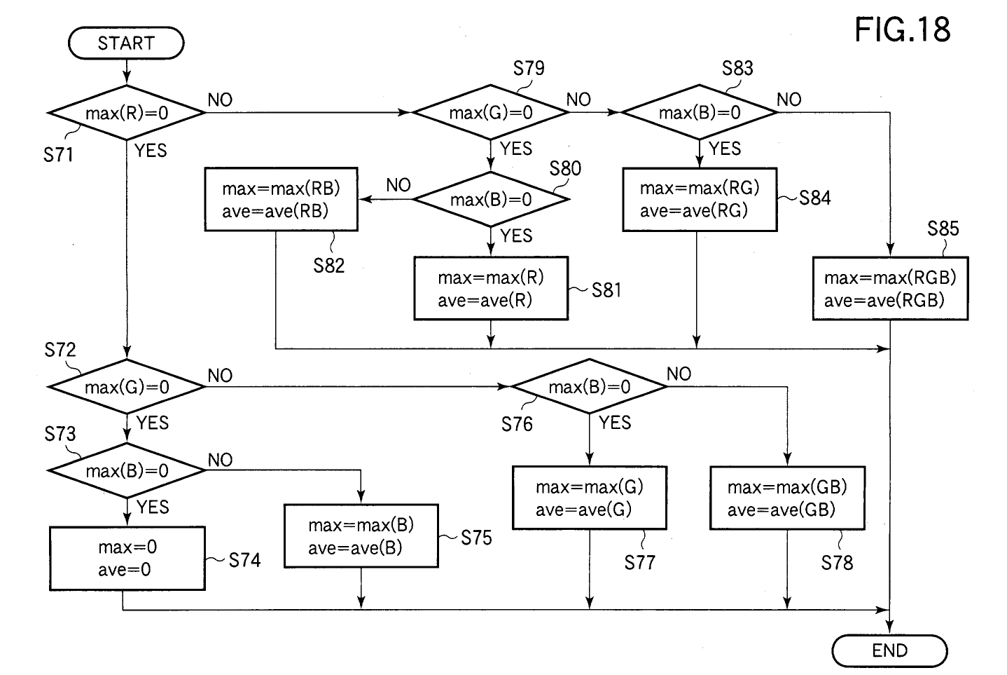

A method of driving a liquid crystal display according to Embodiment 2-5 in the present mode for carrying out the invention will now be described with reference to FIGS. 18 to 24. In the case of an image displayed in only one or two colors out of red, green and blue which is not encountered in displaying ordinary images, the screen will become darker than when displaying white if a duty ratio D is calculated based on a maximum value max or an average value ave of luminance data W. A duty ratio D for an image in only one color, e.g., red will be r/(r+g+b) times that in the case of white display in the above-described example. However, when the maximum value of red max(R) is 63, it is desirable to set the duty ratio D near 100% to display a bright and clear image.

FIG. 18 is a flow chart showing a method of driving a liquid crystal display according to the present embodiment. First, maximum values (max(R), max(G) and max(B)) and average values (ave(R), ave(G) and ave(B)) of data values of image signals R, G and B respectively are calculated. Next, as shown in FIG. 18, max(R) is compared with 0 (step S71). When max(R)=0, max(G) is compared with 0 (step S72). When max(G)=0, max(B) is compared with 0 (step S73). When max(B)=0, a maximum value of 0 and an average value of 0 are set (step S74). When max(B) is not equal to 0, the maximum value is set at max (B), and the average value is set ave(B) (step S75).

When max(G) is not equal to 0 at step S72, max(B) is compared with 0 (step S76). When max(B)=0, the maximum value is set at max(G), and the average value is set at ave(G) (step S77). When max(B) is not equal to 0, the max value is set at max(GB), and the average value is set at ave(GB) (step S78).

When max(R) is not equal to 0 at step S71, max(G) is compared with 0 (step S79). When max(G)=0, max(B) is compared with 0 (step S80). When max(B)=0, the maximum value is set at max(R), and the average value is set at ave(R) (step S81). When max(B) is not equal to 0, the max value is set at max(RB), and the average value is set at ave(RB) (step S82).

When max(G) is not equal to 0 at step S79, max(B) is compared with 0 (step S83). When max(B)=0, the maximum value is set at max(RG), and the average value is set at ave(RG) (step S84). When max(B) is not equal to 0, the max value is set at max(RGB), and the average value is set at ave(RGB) (step S85).

When R, G and B of a certain pixel have values 40, 35 and 0 respectively, luminance data W=RG=(rR+gG)/(r+g) is calculated from a relationship expressed by r:g=7:20, and values max(RG), min(RG) and ave(RG) of the luminance data W are calculated. Average values ave(R), ave(G) and ave(B) may be substituted for values max(R), max(G) and max(B), respectively.

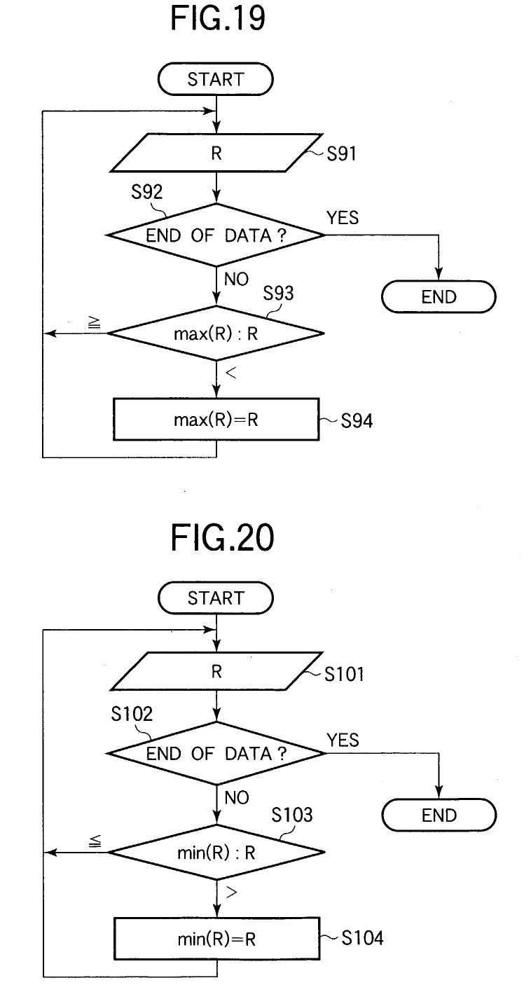

FIG. 19 is a flow chart showing steps for obtaining a maximum value max(R) from an image signal R. First, an image signal R for each pixel is input to the signal analysis section 30 (step S91). When the image signal R is input (step S92), the data value of the signal R is compared with a maximum value max(R) (which is initially 0) (step S93). When the value R is greater than the maximum value max(R) (R>max(R)), the value R is stored in a memory that is not shown as a maximum value max(R) (step S94). When the value R is equal to or smaller than the maximum value max (R) (R≦max(R)), the process returns to step S91. The above steps are repeated until image signals R in a specified range are input.

FIG. 20 is a flowchart showing steps for obtaining a minimum value min(R) from an image signal R. First, an image signal R for each pixel is input to the signal analysis section 30 (step S101). When the image signal R is input (step S102), the data value of the signal R is compared with a minimum value min(R) (which is initially 0) (step S103). When the value R is smaller than the minimum value min(R) (R<min(R)), the value R is stored in a memory that is not shown as a minimum value min(R) (step S104). When the value R is equal to or greater than the minimum value min (R) (R≧min(R)), the process returns to step S101. The above steps are repeated until, image signals R in a specified range are input.

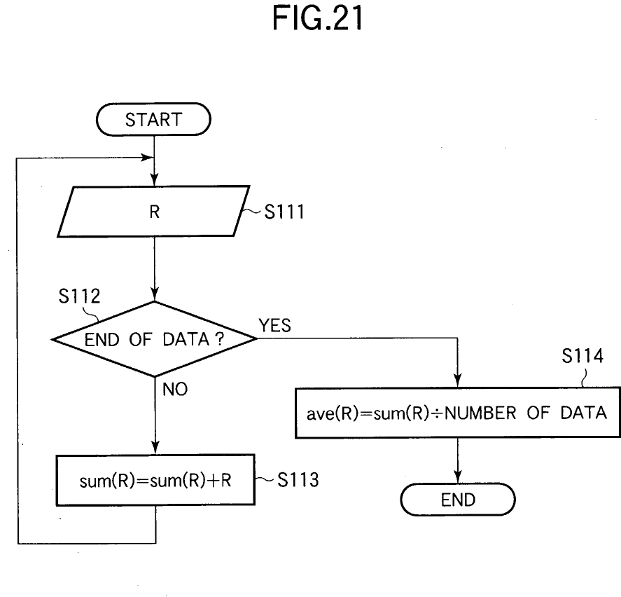

FIG. 21 is a flow chart showing steps for obtaining an average value ave(R) from an image signal R. First, an image signal R for each pixel is input to the signal analysis section 30 (step S111). When image signals R are input (step S112), the data values of the signals R are sequentially added to a total value sum(R) (which is initially 0), and the results are stored in a memory (step S113). The above steps are repeated until image signals R in a specified range are input. When the input of image signals in a specified range is completed (step S112), the total value sum(R) is divided by the number of data to calculate an average value (R) (step S114).

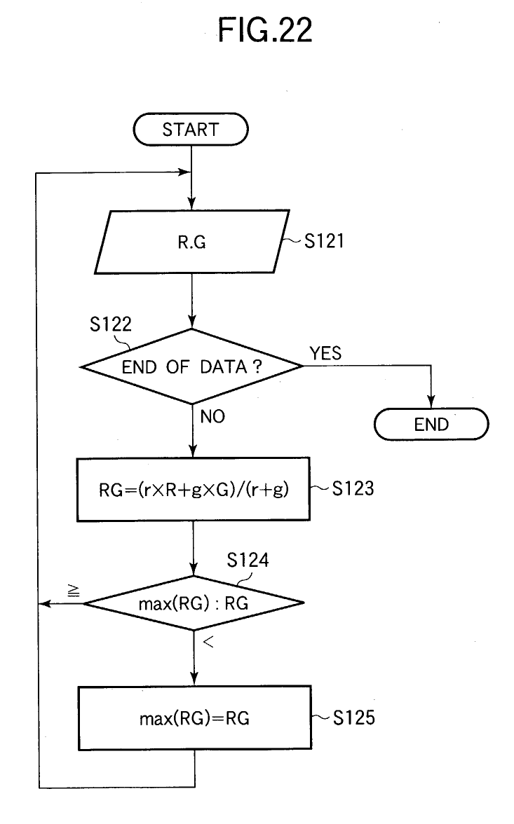

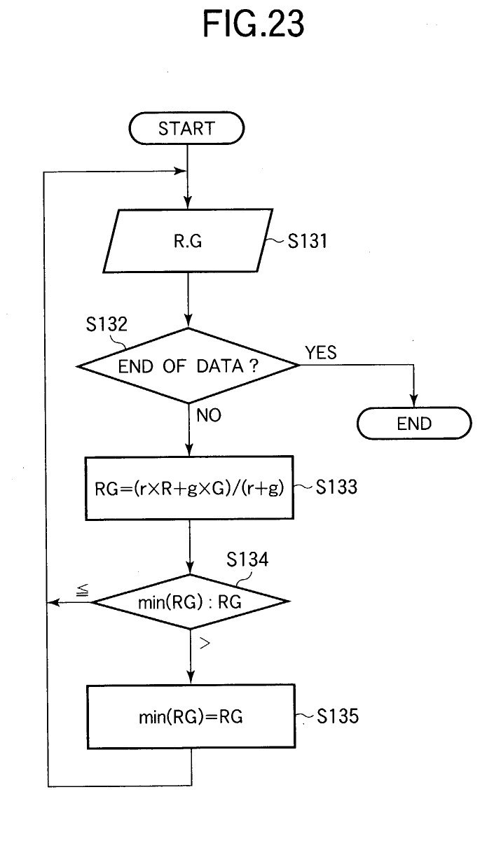

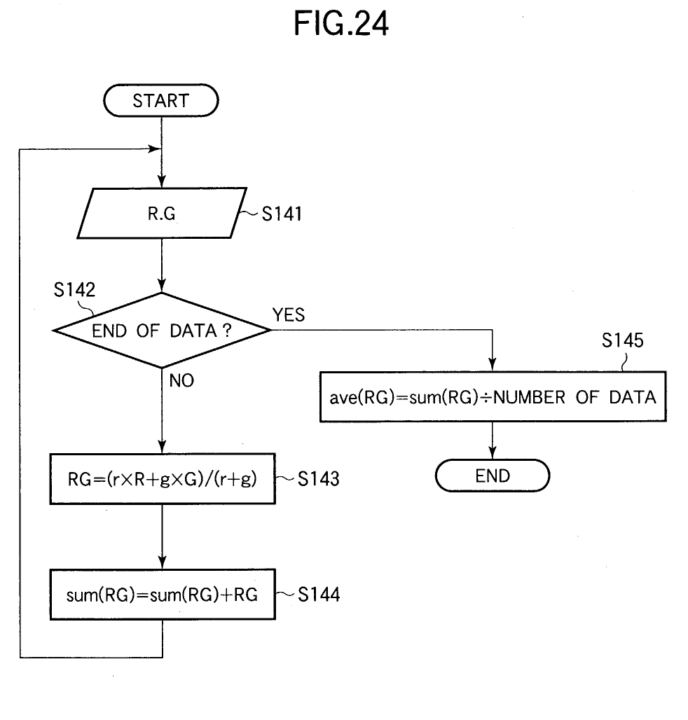

FIG. 22 is a flow chart showing steps for obtaining a maximum value max (RG) from image signals R and G. FIG. 23 is a flow chart showing steps for obtaining a minimum value min (RG) from image signals R and G. FIG. 24 is a flow chart showing steps for obtaining an average value ave (RG) from image signals R and G. Those steps will not be described here because they are similar to the steps shown in FIGS. 19 to 21.

When there is a sufficient memory capacity in performing the above-described calculations, image signals for several frames are stored; the values max(R), max(G) and max(B) are calculated from the image signals; and luminance data W is calculated again to calculate the values max, min and ave. Thereafter, the images are displayed with a predetermined time lag. If there is a sufficient processing capacity, image signals for one frame are stored to calculate the values max(R), max(G) and max(B) and any of luminance data W=(rR+gG)/(r+g), luminance data W=(gG+bB)/(g+b), luminance data W=(bB+rR)/(b+r) and luminance data W=(rR+gG+bB)/(r+g+b) substantially simultaneously.

The present embodiment makes it possible to display even an image in only one or two colors among red, green and blue with high luminance.

(Embodiment 2-6)

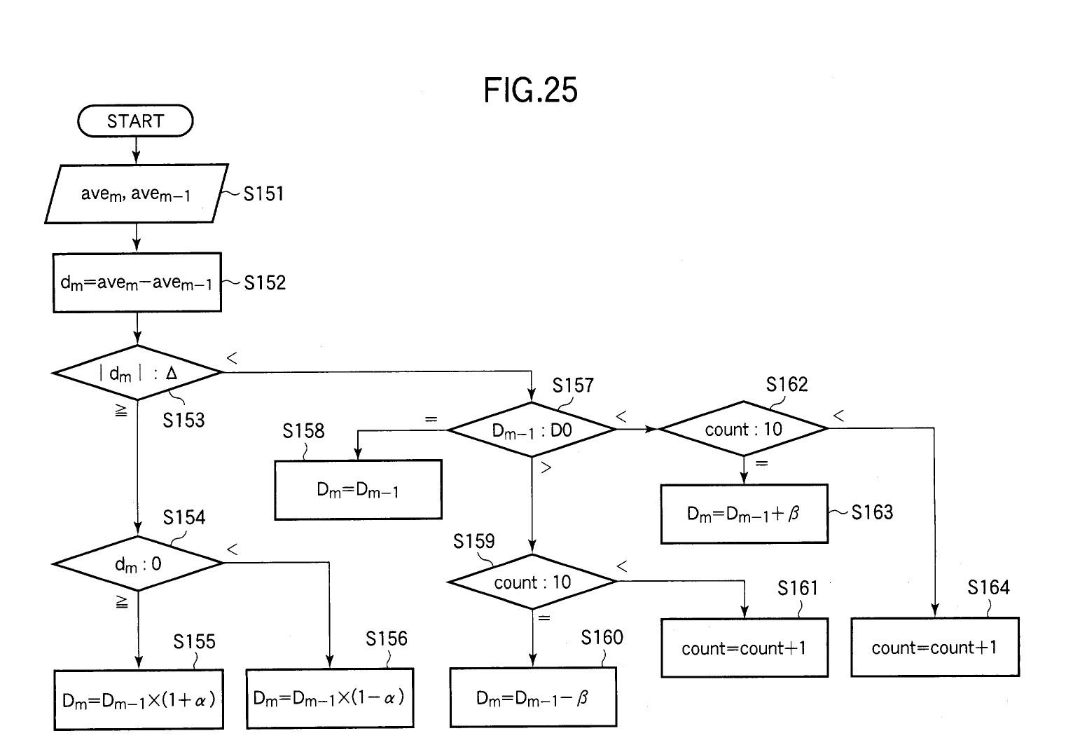

A method of driving a liquid crystal display according to Embodiment 2-6 in the present mode for carrying out the invention will now be described with reference to FIG. 25. In the present embodiment, a duty ratio D is changed depending on changes in the image with time. When an average value ave of luminance data W significantly changes in a unit time, the duty ratio D is changed in adaptation to the change. This makes it possible to obtain a striking image on which changes in display luminance are emphasized. On the contrary, when changes in the average value ave are small, the duty ratio D is gradually changed toward a certain reference value D0. The reference value D0 may be a constant value such as 80% and may alternatively be decreased with an increase of the average value ave in order to reduce the glare of a display screen for comfort of a viewer's eyes when the average value is great (or when the screen as a whole appears in near-white).

For example, a viewer can continue watching a screen in comfort without feeling glare from a near-still image (or still image) of characters displayed on a white background when D0=80 (where ave≦24) or when D0=100−(ave×50)/63 (where ave≧25).

FIG. 25 is a flow chart showing steps for changing a duty ratio D in adaptation to changes of an average value ave. Let us assume that aveₘ represents an average value ave of a certain frame; Dₘ represents a duty ratio to be determined; and aveₘ₋₁ and Dₘ₋₁ represents an average value ave and a duty ratio of the preceding frame, respectively. As shown in FIG. 25, the signal analysis section 30 reads an average value ave of each frame (step S151). The signal analysis section 30 obtains a value dₘ=aveₘ−aveₘ₋₁ (step S152) and compares |dₘ| with a predetermined value Δ (step S153). When |dₘ|≧Δ, it compares dₘ with 0 (step S154). When dₘ≧Δ, the duty ratio Dₘ is obtained from Dₘ=Dₘ₋₁×(1+α) (step S155). When dₘ<Δ, the duty ratio Dₘ is obtained from Dₘ=Dₘ₋₁×(1−α) (step S156).

When |dₘ|<Δ at step S153, the duty ratio Dₘ₋₁ is compared with a reference value D0 (step S157). When Dₘ₋₁=D0, the duty ratio Dₘ is set at Dₘ₋₁ (step S158). When Dₘ₋₁>D0, a count value count is compared with 10, for example (step S159). When count=10, the duty ratio Dₘ is obtained from Dₘ=Dₘ₋₁−β (step S160). When count<10, the count value count is count+1 (step S161).

When Dₘ₋₁<D0 at step S157, the count value count is compared with 10 (step S162). When count=10, the duty ratio Dₘ is obtained from Dₘ=Dₘ₋₁+β (step S163). When count<10, the count value count is count+1 (step S164).

For example, preferable display having impressive changes in brightness can be presented when the values Δ, α and β are set at 2, 0.3 and 1, respectively. In order to reliably decrease a duty ratio D when black is displayed throughout a display screen, the duty ratio D is set at a low value such as 20% by detecting an average value ave of 0 and a maximum value of 0. Even when the average value ave is equal to 0, the duty ratio D is increased to 80% or more, for example, when the maximum value max is not equal to 0 to highlight white characters displayed on a black background, for example. For example, when pixels having a maximum value of 63 consecutively reside in the horizontal or vertical direction of a display screen because of uneven distribution of high tones to display characters, the duty ratio D is set at 100%, for example. This makes it possible to display an image that appears striking to a viewer.

As described above, by changing the duty ratio D, it is possible to obtain an image in which changes in the brightness of display are emphasized. In order to prevent a dynamic image from appearing dark as a whole, the following measure is taken. When the duty ratio D is decreased, the image is displayed with tone data of the same converted upward. There will be no reduction in the luminance of display when the decrease in the duty ratio D balances the upward change of the tone. When the tone data is displayed after converting it by dividing the initial tone data by the duty ratio that changes in the range from 50 to 100%, an image having a wide dynamic range can be obtained which seems to have reduced luminance of black with the luminance of the screen kept high.

Alternatively, γ-characteristics may be changed instead of converting the tone data. Further, by increasing the γ-value when the duty ratio D is conversely increased, an image appears brighter than display with a duty ratio D of 100%, and a wide dynamic range can be thus achieved.

While examples have been shown in which a duty ratio is changed or an image is processed in one frame period or in a display area as a whole, one screen can be more minutely processed by dividing the display area into a plurality of sections. For example, let us assume a display area as two separate upper and lower regions that are associated with fluorescent tubes provided on top and bottom edges of a planar light guide plate of a side-light type backlight unit. Then, a maximum value max, a minimum value min and an average value ave of pixel data for each of the upper and lower halves of the display area (=½ of flame) are calculated, and the upper and lower regions have duty ratios D different from each other. In the case of an image in which white clouds in blue sky appear in the upper half of the display screen and in which a water mill appears in the lower half, the duty ratio D for the upper half is set higher, and the duty ratio D for the lower half is set lower than that for the upper half. Thus, the fine sky and white cloud can be highlighted, and the water mill can be rendered with a realistic feel.

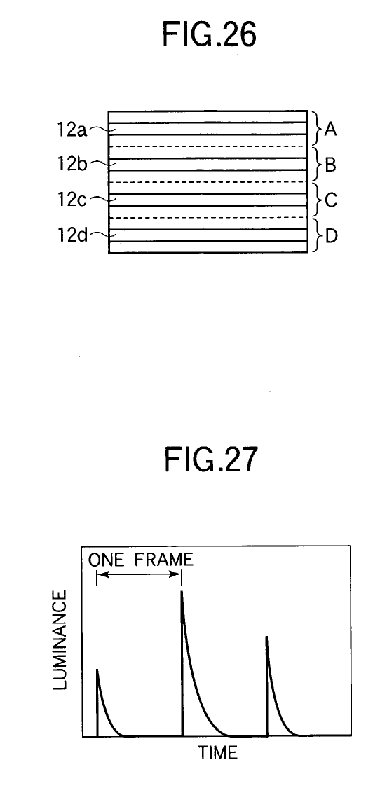

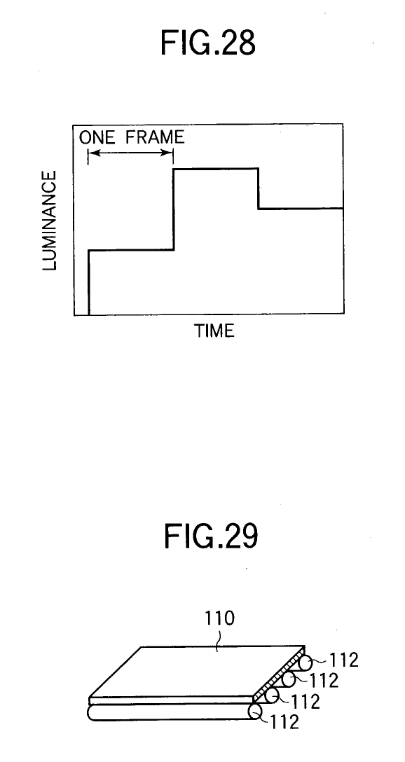

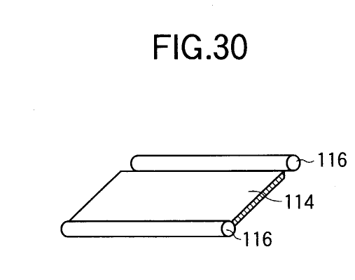

The display area may be further divided finely in the vertical direction and may be vertically scanned using a direct type backlight unit. FIG. 26 shows an example in which a display area is divided into four regions A to D using four fluorescent tubes 12a to 12d. Better display characteristics can be achieved by thus dividing a display area into a plurality of regions and by scanning each of the regions with an adequate duty ratio D calculated for the same. Further, a plurality of LEDs arranged in the form of a matrix may be used as light sources, and a duty ratio may be calculated for each of the regions divided in association with the LEDs to cause each of the LEDs to blink in accordance with the duty ratio.

In the present mode for carrying out the invention, the output of a backlight unit can be increased to maintain a maximum luminance when displaying an image in a light color. When an image in black or a similar dark color is displayed, the output of the backlight unit can be decreased to enhance the black. This makes it possible to achieve a wide dynamic range. It is also possible to display clear black by reducing highlights in black depending on viewing angles and to obtain a striking image by emphasizing changes in the brightness of the image. It is also possible to achieve a reduction in power consumption.

The invention is not limited to the above-described modes for carrying out the same and may be modified in various ways.

For example, while a backlight unit is used as a light source device in the above-described modes for carrying out the invention, the invention is not limited to the same, and a front-light unit may alternatively be used.

As described above, the invention makes it possible to provide a liquid crystal display having good display characteristics.

What is claimed is:

1. A liquid crystal display comprising:
a liquid crystal display panel having a two substrates provided opposite to each other and a liquid crystal sealed between the two substrates; and
a light source device having a planar light guide plate for guiding light incident thereupon and a plurality of linear light sources that are provided at an edge of the planer light guide plate and that are turned on for a predetermined turn-on time within a frame period at predetermined blinking frequency and at different timing.

2. A liquid crystal display according to claim 1, wherein the turn-on time is different for each of the plurality of linear light sources.

3. A liquid crystal display according to claim 1, wherein the turn-on time is divided into times at the beginning and end of the frame period.

4. A liquid crystal display according to claim 3, wherein the ratio of the turn-on time to the frame period is 40% or more.

5. A liquid crystal display according to claim 1, wherein the blinking frequency is equal to a frame frequency.

6. A liquid crystal display according to claim 1, wherein the plurality of linear light sources are provided at a plurality of edges of the single planar light guide plate respectively.

7. A liquid crystal display according to claim 1, wherein the planar light guide plate has a splitting surface at which the plate is partially divided substantially in parallel with a light entering surface substantially midway between the positions where the plurality of linear light sources are provided.

8. A liquid crystal display according to claim 1, wherein a plurality of the planar light guide plates are provided for each of the plurality of linear light sources.

9. A liquid crystal display according to claim 8, wherein the planar light guide plates have a wedge-like configuration.

10. A liquid crystal display according to claim 1, wherein a plurality of the planar light guide plates are provided one over the other.

11. A liquid crystal display according to claim 1, further comprising an optical shutter that is provided on a side of the planar light guide plate facing toward the liquid crystal display panel and that is capable of substantially blocking light.

12. A light source device comprising:
a planar light guide plate for guiding light incident thereupon; and
a plurality of linear light sources that are provided at an edge of the planer light guide plate and that are turned on for a predetermined turn-on time within a frame period at predetermined blinking frequency and at different timing.

13. A method of driving a liquid crystal display having a plurality of planar light sources, comprising the step of turning on each of the plurality of planar light sources for a predetermined turn-on time at different timing in a frame period.

14. A method of driving the liquid crystal display according to claim 13, wherein the planar light sources have a planar light guide plate for guiding light incident thereupon and a linear light source provided at an edge of the planar light guide plate and wherein the linear light sources are turned off while pixel data is written in a display area on the side of the linear light sources.

15. A method of driving a liquid crystal display, comprising the steps of:
calculating luminance data for each pixel based on the tone of the pixel in a predetermined period;
calculating a duty ratio that is the ratio of a turn-on time to the predetermined period based on at least any of a maximum value, a minimum value, and an average value of the luminance data; and
blinking a planar light source based on the duty ratio.

16. A method of driving a liquid crystal display according to claim 15, wherein the luminance data is obtained for each of R (red), G (green), and B (blue) pixels.

17. A method of driving a liquid crystal display according to claim 15, wherein the tone is changed based on the duty ratio.

18. A method of driving a liquid crystal display according to claim 15, wherein a γ-value is changed based on the duty ratio.

19. A method of driving a liquid crystal display according to claim 15, wherein the predetermined period is equal to a frame period.
